(19) United States
(12) Patent Application Publication
(10) Pub. No.: US 2006/0078119 A1
(43) Pub. Date: Apr. 13, 2006

(54) Bootstrapping method and system in mobile network using diameter-based protocol

(76) Inventors: Jung Hoon Jee, Daejeon-city (KR); Jae Hoon Nah, Daejeon-city (KR); Kyo Il. Chung, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/177,528

(22) Filed: Jul. 7, 2005

(30) Foreign Application Priority Data
Oct. 11, 2004 (KR) 10-2004-0081116

(51) Int. Cl. H04K 1/00

(52) U.S. Cl. 380/247

(57) ABSTRACT

A bootstrapping method and system in a mobile network using a Diameter-based protocol are provided. The bootstrapping system includes; a mobile node, connecting to a local network, which creates and transmits an AAA request message; and a home AAA server of a home network, which authenticates the mobile node based on the AAA request message received through a local AAA server of the local network, allocates a home agent and a home address relating to the mobile node, transmits the address of the home agent and the home address along with Internet key exchange (IKE) phase 1 security key material to the mobile node, and transmits an IKE phase 1 security key to the home agent, wherein the mobile node generates the IKE phase 1 security key using the IKE phase 1 security key material, distributes IP security (IPsec) security agreement (SA) with the home agent using IKE phase 2, and performs a binding update with the home agent using distributed IPsec SA. Therefore, the bootstrapping system can dynamically initialize the mobile node, using a Diameter infrastructure.

### BACKGROUND OF THE INVENTION

This application claims the priority of Korean Patent Application No. 10-2004-0081116, filed on Oct. 11, 2004, in the Korean Intellectual Property Office, the disclosure of which is incorporated herein in its entirety by reference.

1. Field of the Invention

The present invention relates to a bootstrapping method and system in a mobile network, and more particularly, to a method and system for supporting secure bootstrapping in a diameter-based mobile network.

2. Description of the Related Art

In U.S. Pat. No. 6,466,571 B1, entitled “Radius-Based Mobile Internet Protocol (IP) Address-to-Mobile Identification Number Mapping for Wireless Communication”, a RADIUS authentication server maintains mapping information of an IP address for a device and an identification number uniquely associated with the device, so that a home agent can support mobility of the device without managing location information based on the IP address. The RADIUS authentication server sends an access-accept packet to the home agent in the event that the device is authorized to receive the IP packet, in which case the access-accept packet includes the identification information. The home agent uses the identification number to locate, page and automatically connect the wireless device to an IP network. Therefore, the home agent can support mobility of the device between networks without managing the IP address of the wireless device.

IETF AAA Working Group focuses on development of an IETF Standards track protocol for “Diameter Mobile IPv6 Application”. The Diameter Mobile IPv6 Application distributes a security agreement (SA) key in order to perform a binding update, locate the home agent, and protect the binding update in a cycle of AAA (Authentication/Authorization/Accounting), which reduces the signaling overhead.

In Korean Patent Application No. 2000-87597, entitled “Method of Embodying Local Authentication/Authorization/Accounting Function in All-IP Networks”, a room area network (RAN) includes a local authentication/authorization/accounting server for authentication, authorization and accounting, and when authentication is required for a subscriber to the RAN, the local authentication/authorization/accounting server authenticates the subscriber and sends notice of the transaction to an authentication/authorization/accounting server in a core network, so that the RAN can perform authentication/authorization/accounting function itself instead of relying on the core network.

### SUMMARY OF THE INVENTION

The present invention provides a bootstrapping method and system for dynamically initializing a mobile device, utilizing a secure AAA infrastructure, and supporting roaming between networks in a diameter-based mobile network.

According to an aspect of the present invention, there is provided a bootstrapping system in a mobile network, comprising: a mobile node which connects to a local network, and creates and transmits an AAA request message; and a home AAA server of a home network, which authenticates the mobile node based on the AAA request message received through a local AAA server of the local network, allocates a home agent and home address relating to the mobile node, transmits the address of the home agent and the home address along with Internet key exchange (IKE) phase 1 security key material to the mobile node, and transmits an IKE phase 1 security key to the home agent, wherein the mobile node generates the IKE phase 1 security key using the IKE phase 1 security key material, distributes IP security (IPsec) security agreement (SA) with the home agent using IKE phase 2, and performs a binding update with the home agent using distributed IPsec SA.

According to another aspect of the present invention, there is provided an bootstrapping method in a home AAA server of a mobile network, comprising: receiving an AAA request message including a network access identifier from a mobile node; authenticating the mobile node based on the network access identifier, allocating a home agent and a home address relating to the mobile node, and establishing an IKE phase 1 security key; and transmitting the authentication result of the mobile node and the IKE phase 1 security key to the home agent, transmitting the address of the home agent, the home address, and IKE phase 1 security key material to the mobile node, to form a secure channel between the mobile node and home agent.

According to still another aspect of the present invention, there is provided an bootstrapping method in a mobile network, comprising: transmitting an AAA request message, created by a mobile node that accesses a local network, to a home AAA server of a home network through a local AAA server of the local network; the home AAA server authenticating the mobile node based on the AAA request message, allocating a home agent and a home address relating to the mobile node, and establishing an IKE phase 1 security key; the home AAA server transmitting the address of the home agent, the home address, and IKE phase 1 security key material to the mobile node, and transmitting the authentication result of the mobile node and the IKE phase 1 security key to the home agent; the mobile node generating the IKE phase 1 security key using the IKE phase 1 security key material to form a secure channel with the home agent, and performing IKE phase 2 to distribute IPsec SA with the home agent; and performing a binding update of the mobile node using IPsec SA.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a bootstrapping system in a mobile network according to an embodiment of the present invention;

FIG. 2 is a flow chart of a bootstrapping method in a mobile network according to an embodiment of the present invention;

FIG. 3 is a flow chart of the bootstrapping method according to an embodiment of the present invention in view of a mobile node;

FIG. 4 is a flow chart of the bootstrapping method according to an embodiment of the present invention in view of a home AAA server;

FIG. 5 is a flow chart of the bootstrapping method according to an embodiment of the present invention in view of a home agent;

FIG. 6 is a diagram of an AAA client request (ACR) message format;

FIG. 7 is a diagram of a MIPv6-Feature-Vector message format;

FIG. 8 is a diagram of a message format of a Home-Agent-MIPv6-Request (HOR) Diameter command;

FIG. 9 is a diagram of a message format of a Home-Agent-MIPv6-Answer (HOA) Diameter command; and

FIG. 10 is a diagram of a message format of an AAA Client Answer (ACA) Diameter command.

### DETAILED DESCRIPTION OF THE INVENTION

Hereinafter, the present invention will be described in detail by explaining preferred embodiments of the invention with reference to the attached drawings.

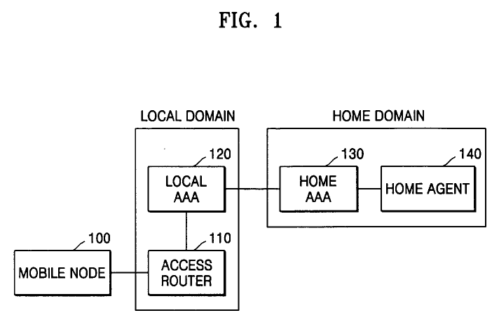

FIG. 1 is a block diagram of a bootstrapping system in a mobile network according to an embodiment of the present invention. Referring to FIG. 1, the mobile network comprises a user device, i.e., a mobile node 100, an access router 110 needed to allow the mobile node 100 to gain access to a new network, a local AM server 120 for performing authentication/authorization/accounting (AAA) in a local network to which the mobile node 100 is connected, a home AAA server 130 for performing authentication/authorization/accounting (AAA) in a home network, and a home agent 140 for managing location information of the mobile node 100 in the home network.

Bootstrapping according to the present invention is based on a diameter protocol, capable of transferring roaming information of a device between networks. The diameter protocol is well known in the art to which the present invention pertains, and thus will not be described here in detail.

The bootstrapping method will now be described with reference to FIG. 1.

When the mobile node 100 gains access to a new network (local network), it receives a router advertisement message including a random value, i.e., a local challenge (LC) value from the access router (or attendant) 110 of the local network. The mobile node 100 creates an AAA request message including an LC, a replay protection indicator (RPI), a network access identifier (NAI), a credential (CR), and a bootstrap flag value (B_flag) of “1” for requesting bootstrap, and transmits the AAA request message to the access router 110.

The access router 110 inspects the LC value included in the AAA request message so as to prevent the AAA request message from being reused. RPI is a random value used to prevent the AAA request message from being reused between the mobile node 100 and the home AAA server 130. CR is a value generated to allow the mobile node 100 to receive authentication/authorization of the AAA request message from the home AAA server 130. NAI is an identifier used to identify a user when the mobile node 100 gains access to a network service, which is described in detail in RFC 2486 (The Network Access Identifier) (www.ieff.org).

The access router 110 receives the AAA request message from the mobile node 100, inspects the LC value included in the AAA request message to verify the novelty of the AAA request message, creates an AAA client request (ACR) message in a diameter message format based on information included in the AAA request message, and transmits the ACR message to the local AAA server 120. The local AAA server 120 transmits the ACR message to the home AAA server 130 in the home network of the mobile node 100.

The home AAA server 130 performs authentication of the mobile node 100 based on NAI (RFC 2486) included in the ACR message transmitted from the local AAA server 120. When authentication proves successful, the home AAA server 130 allocates the home agent (HA) 140 relating to the mobile node 100 among a plurality of home agents in the home network, and allocates a home address relating to the mobile node 100. The home AAA server 130 establishes an Internet key exchange (IKE) phase 1 security key in order to form a secure channel between the mobile node 100 and home agent 140, transmits the IKE phase 1 security key to the home agent 140, and an IKE phase 1 security key material to the mobile node 100.

IKE is composed of phase 1 and phase 2, in which phase 1 obtains a secure channel between IKE negotiation entities, and phase 2 distributes Internet protocol security (IPSec) SA through the secure channel obtained by phase 1. IKE is defined in RFC 2409 (www.ietf.org), and the IETF Working Group focuses on IKE version 2 (IKEv2) Standards. Since the present invention forms the secure channel between the mobile node 10 and home agent 140, a variety of versions are applied to the present invention according to IKEv2 Standards.

To be more specific, the home AAA server 130 transmits an authentication result and the IKE phase 1 security key to the home agent 140. The home agent 140 establishes the authentication result and IKE phase 1 security key, and transmits the result to the home AAA server 130.

The home AAA server 130 transmits a home agent address, home address, and the IKE phase 1 security key material to the mobile node 100 through the local AAA server 120 and access router 110. The mobile node 100 establishes the home agent address and home address, and generates the IKE phase 1 security key from the IKE phase 1 security key material.

The mobile node 100 obtains the secure channel with the home agent 140 using the IKE phase 1 security key, and performs IKE phase 2 through the obtained secure channel to distribute IPSec SA with the home agent 140.

The mobile node 100 performs a binding update to the home agent 140 using IPSec SA.

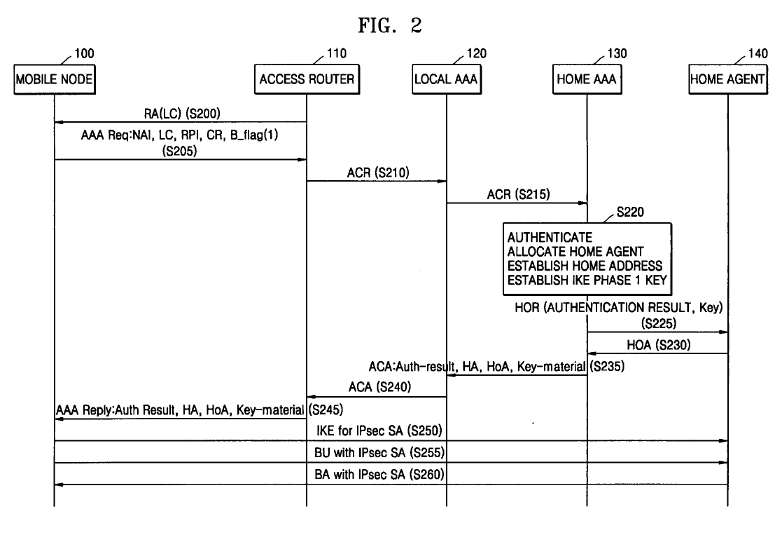

FIG. 2 is a flow chart of a bootstrapping method in a mobile network according to an embodiment of the present invention. Referring to FIG. 2, the mobile node 100 receives a router advertisement message including LC from the access router 110 on an adjacent network (Operation 200). The mobile node 100 creates an AAA request message including a RPI, NAI, CR, and a bootstrap flag value (B_flag) of “1” for requesting bootstrap using LC, and transmits the AAA request message to the access router 110 (Operation 205).

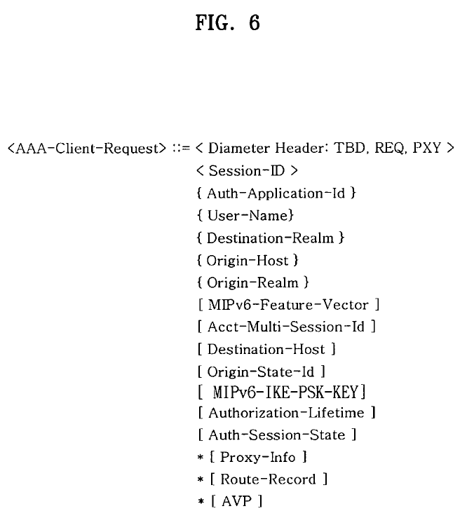

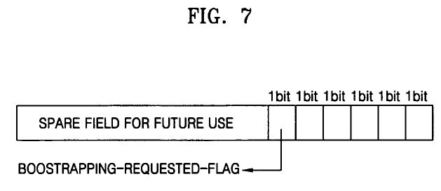

The access router 110 receives the AAA request message from the mobile node 100, inspects an LC value included in the AAA request message to verify the novelty of the AAA request message, creates an ACR message in a diameter message format based on information included in the AAA request message. An ACR message format is illustrated in FIG. 6. Each field of the ACR message is defined in the IETF Diameter Standards. User-Name AVP stores a user's NAI value. MIPv6-Feature-Vector has an unsigned 32 bits format as illustrated in FIG. 7. Diameter Mobile IPv6 Application defines flag values corresponding to decimal numerals 1, 2, 4, 8, and 16. The present invention defines a flag value “32” (decimal numeral) as the value to identify a bootstrapping request.

The access router 110 transmits the ACR message to the home AAA server 130 through the local AAA server 120 (Operation 215).

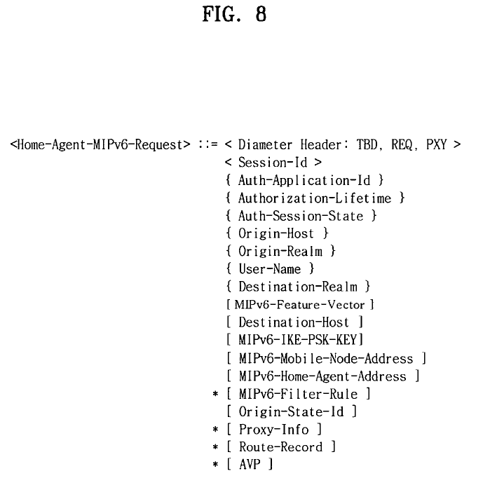

The home AAA server 130 performs authentication of the mobile node 100 based on NAI suggested by the mobile node 100, and inspects MIPv6-Feature-Vector AVP included in the ACR message. When the Bootstrapping-Requested-Flag of a MIPv6-Feature-Vector AVP value is “1”, the home AAA server 130 allocates the home agent 140 relating to the mobile node 100, and establishes the home address and IKE phase 1 security key (Operation 220). The home AAA server 130 transmits an authentication result and the IKE phase 1 security key to the home agent 140 (Operation 225). The message format of a Home-Agent-MIPv6-Request (HOR) Diameter command is illustrated in FIG. 8. The IKE phase 1 security key is stored in the MIPv6-Feature-Vector AVP of a HOR message before being transmitted. Each field of the HOR message is defined in the IETF Diameter Standard.

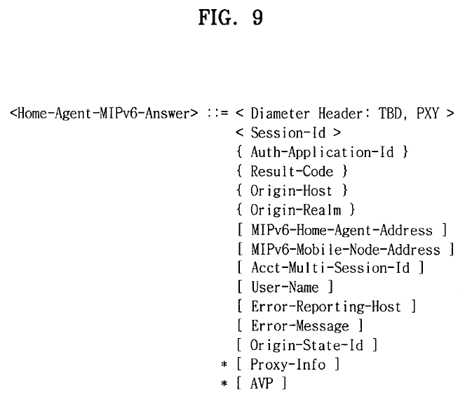

The home agent 140 establishes authentication information and the IKE phase 1 security key, and transmits an answer message corresponding to the HOR message to the home AAA server 130 (Operation 230). The message format of a Home-Agent-MIPv6-Answer (HOA) Diameter command is illustrated in FIG. 9. Each field of a HOA message is defined in the IETF Diameter Standard.

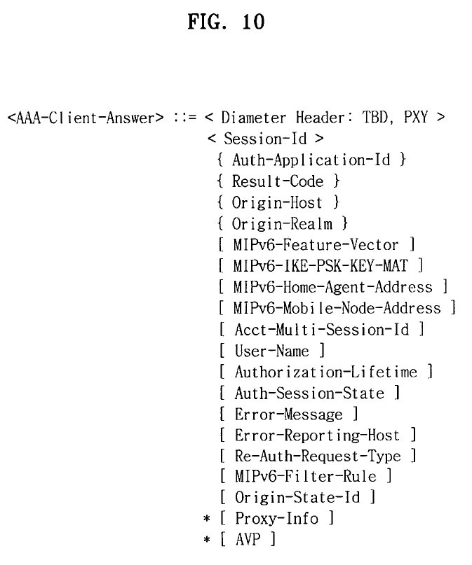

The home AAA server 130 receives the answer message from the home agent 140, and transmits the authentication result, the home agent address, an establishment value of the home address, and the IKE phase 1 security key material to the access router 110 through the local AAA server 120 (Operations 235 and 240). The message format of an AAA client answer (ACA) Diameter command is illustrated in FIG. 10. Each field of an ACA message is defined in the IETF Diameter Standard. The IKE phase 1 security key material is stored in the MIPv6-IKE-PSK-MAT AVP of the ACA message. The address of the home agent 140 is stored in the MIPv6-Home-Agent-Address AVP, and the home address of the mobile node 100 is stored in the MIPV6-Mobile-Node-Address AVP.

The access router 110 establishes the access rights of the mobile node 100 according to the authentication result, and transmits an AAA reply message to the mobile node 100. The reply message includes the authentication result, the address of the home agent (HA) 140, the home address (HoA), and IKE phase 1 security key material.

The mobile node 100 generates an IKE phase 1 security key using the IKE phase 1 security key material, and obtains the secure channel with the home agent 140. The mobile node 100 performs IKE phase 2 negotiation through the secure channel, and distributes IPSec SA with the home agent 140 (Operation 250).

The mobile node 100 transmits a binding update message to the home agent 140 using IPSec SA (Operation 255), and receives a binding acknowledge (BA) message regarding a binding update result from the home agent 140 (Operation 260).

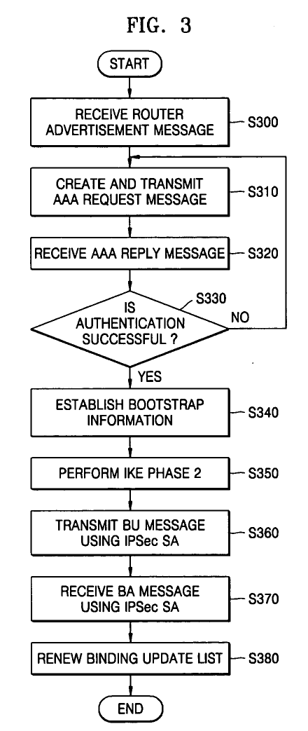

FIG. 3 is a flow chart of the bootstrapping method according to an embodiment of the present invention in view of the mobile node 100. Referring to FIGS. 2 and 3, the mobile node 100 receives the router advertisement message from the access router 110 (Operation 300). The mobile node 100 creates the AAA request message using LC included in the route advertisement message, and transmits the AAA request message to the home AAA server 130 through the access router 110 and local AAA server 120 (Operation 310).

The mobile node 100 receives the AAA reply message including message processing results of the home AAA server 130 and the home agent 140 (Operation 320). The AAA reply message includes the authentication result, the address of the home agent (HA) 140, the home address (HoA), and IKE phase 1 security key material.

When the authentication result included in the AAA reply message indicates successful authentication (Operation 330), the mobile node 100 establishes bootstrap information (home agent address, home address) (Operation 340), and generates an IKE phase 1 security key based on the IKE phase 1 security key material included in the AAA reply message (Operation 340).

The mobile node 100 obtains the secure channel with the home agent 140 to perform IKE phase 2 and distribute IPSec SA with the home agent 140 (Operation 350). The mobile node 100 transmits the binding update (BU) message using IPSec SA to the home agent 140 (Operation 360), and receives the binding acknowledge message from the home agent 140 (Operation 370).

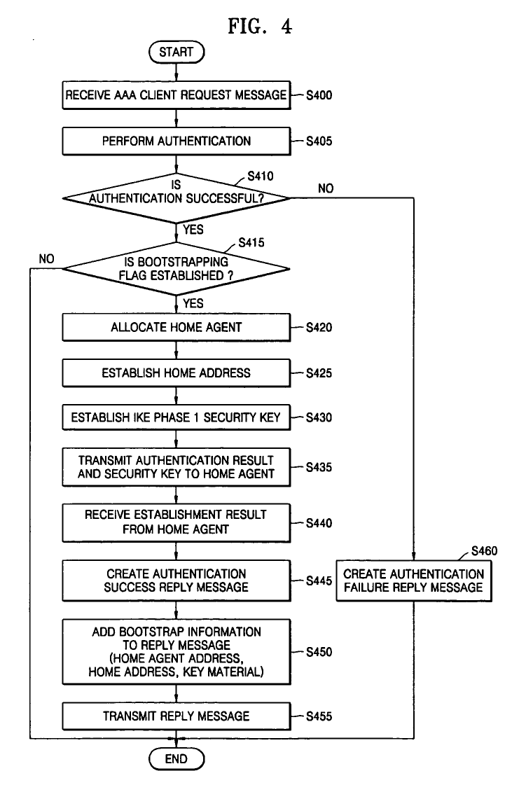

FIG. 4 is a flow chart of the bootstrapping method according to an embodiment of the present invention in view of the home AAA server 130. Referring to FIGS. 2 and 4, the home AAA server 130 receives the ACR message (Operation 400). The home AAA server 130 performs authentication of the mobile node 100 based on NAI information of the mobile node 100 included in the ACR message (Operation 405). When authentication fails (Operation 410), the home AAA server 130 creates an authentication failure reply message (Operation 460). When authentication proves successful (Operation 410), the home AAA server 130 inspects the ACR message for the flag value to request the bootstrap through MIPv6-Feature-Vector AVP (Operation 415).

If the ACR message establishes the Bootstrapping-Requested flag to request the bootstrap, the home AAA server 130 allocates the home agent 140 relating to the mobile node 100 (Operation 420), and establishes the home address relating to the mobile node 100 (Operation 425) and IKE phase 1 security key (Operation 430).

The home AAA server 130 transmits the authentication result and IKE phase 1 security key to the home agent 140 (Operation 435), and receives the establishment result of the IKE phase 1 security key from the home agent 140 (Operation 440). The home AAA server 130 creates an authentication success reply message (Operation 445), adds bootstrap information (the address of the home agent 140, the home address, and IKE phase 1 security key material) to the authentication success reply message (Operation 450), and transmits the authentication success reply message to the mobile node 100 (Operation 455).

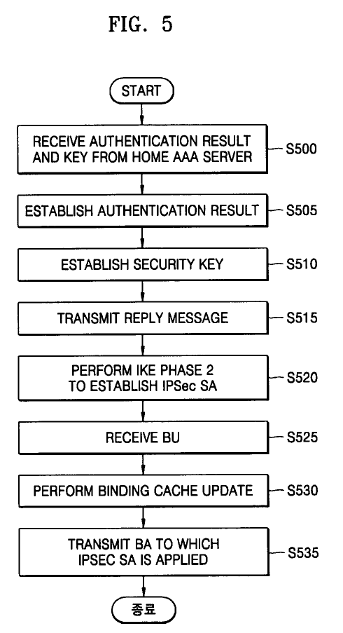

FIG. 5 is a flow chart of the bootstrapping method according to an embodiment of the present invention in view of the home agent 140. Referring to FIGS. 2 and 5, the home agent 140 receives the authentication result and the IKE phase 1 security key from the home AAA server 130 (Operation 500). The home agent 140 establishes the authentication result and the IKE phase 1 security key (Operations 505 and 510), and transmits the reply message (Operation 515).

The home agent 140 obtains the secure channel using the IKE phase 1 security key with the mobile node 100, and performs IKE phase 2 through the secure channel to establish IPSec SA (Operation 520). The home agent 140 receives the BU message from the mobile node 100 using IPSec SA (Operation 530), and transmits the BA message to the mobile node 100 using IPSec SA (Operation 535).

According to the present invention, the diameter-based mobile IPv6 protocol bootstrapping can dynamically initialize a mobile device, utilize a secure AAA infrastructure, and use Diameter technology to support roaming between networks, thereby effectively implementing the mobile IPv6 protocol.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A bootstrapping system in a mobile network, comprising:
a mobile node which connects to a local network, and creates and transmits an AAA request message; and
a home AAA server of a home network, which authenticates the mobile node based on the AAA request message received through a local AAA server of the local network, allocates a home agent and home address relating to the mobile node, transmits the address of the home agent and the home address along with Internet key exchange (IKE) phase 1 security key material to the mobile node, and transmits an IKE phase 1 security key to the home agent,
wherein the mobile node generates the IKE phase 1 security key using the IKE phase 1 security key material, distributes IP security (Ipsec) security agreement (SA) with the home agent using IKE phase 2, and performs a binding update with the home agent using distributed IPsec SA.

2. The bootstrapping system of claim 1, wherein the mobile node generates and transmits the AAA request message including a network access identifier, and
the home AAA server performs authentication of the mobile node based on the network access identifier.

3. The bootstrapping system of claim 1, wherein the home agent receives an authentication result of the mobile node and the IKE phase 1 security key from the home AAA server, and establishes information on the authentication result and the IKE phase 1 security key.

4. The bootstrapping system of claim 1, wherein the mobile node establishes bootstrap information including the address of the home agent, the home address, and the IKE phase 1 security key generated from the IKE phase 1 security key material.

5. The bootstrapping system of claim 1, wherein the mobile node, the local AAA server, the home AAA server, and the home agent use a Diameter protocol.

6. A bootstrapping method in a home AAA server of a mobile network, comprising:
receiving an AAA request message including a network access identifier from a mobile node;
authenticating the mobile node based on the network access identifier, allocating a home agent and a home address relating to the mobile node, and establishing an IKE phase 1 security key; and
transmitting the authentication result of the mobile node and the IKE phase 1 security key to the home agent, transmitting the address of the home agent, the home address, and IKE phase 1 security key material to the mobile node, to form a secure channel between the mobile node and home agent.

7. The bootstrapping method of claim 6, further comprising:
transmitting the authentication result of the mobile node and the IKE phase 1 security key to the home agent to allow the home agent to establish authentication result information and the IKE phase 1 security key; and
transmitting the address of the home agent, the home address, and IKE phase 1 security key material to the mobile node to allow the mobile node to generate the IKE phase 1 security key from the IKE phase 1 security key material and to form the secure channel with the home agent.

8. A bootstrapping method in a mobile network, comprising:
transmitting an AAA request message, created by a mobile node that accesses a local network, to a home AAA server of a home network through a local AAA server of the local network;
the home AAA server authenticating the mobile node based on the AAA request message, allocating a home agent and a home address relating to the mobile node, and establishing an IKE phase 1 security key;
the home AAA server transmitting the address of the home agent, the home address, and IKE phase 1 security key material to the mobile node, and transmitting the authentication result of the mobile node and the IKE phase 1 security key to the home agent;
the mobile node generating the IKE phase 1 security key using the IKE phase 1 security key material to form a secure channel with the home agent, and performing IKE phase 2 to distribute IPsec SA with the home agent; and
performing a binding update of the mobile node using IPsec SA.

9. The bootstrapping method of claim 8, further comprising:
the mobile node receiving an advertisement message from an access router of the local network;
creating the AAA request message based on a predetermined random value included in the advertisement message, to transmit the AAA request message to the local AAA server through the access router; and
the local AAA server transmitting the AAA request message to the home AAA server based on a Diameter protocol.

10. The bootstrapping method of claim 8, further comprising:
authenticating the mobile node based on a network access identifier included in the AAA request message.
